(19) United States
(12) Patent Application Publication
(10) Pub. No.: US 2024/0194029 A1
(43) Pub. Date: Jun. 13, 2024

(54) GAMING MACHINE, GAMING METHOD, AND STORAGE MEDIUM

(71) Applicant: Konami Gaming, Inc., Las Vegas, NV (US)

(72) Inventors: Ryu SASAKI, Zama-shi (JP); Daishun OKAMOTO, Zama-shi (JP)

(21) Appl. No.: 18/532,220

(22) Filed: Dec. 7, 2023

(30) Foreign Application Priority Data
Dec. 9, 2022 (JP) 2022-197026

(51) Int. Cl. G07F 17/32; G07F 17/34

(52) U.S. Cl. CPC G07F 17/3267; G07F 17/3211; G07F 17/34

(57) ABSTRACT

A gaming machine includes; an operation unit; a display unit including a symbol display area and a payline display area, the symbol display area configured to display symbols in cells arranged in a grid and being set a plurality of paylines, the payline display area configured to display a payline table; and a control unit configured to change and stop the symbols displayed in the symbol display area, and provide an award based on the symbols stopped in the cells forming the payline, wherein the control unit is configured to: set a chance area associated with an award booster to include a part of paylines indicated in the payline table, the award booster increasing the award; and increase the award using the award booster set in the chance area, the award provided based on the symbols stopped in the cells forming the payline included in the chance area.

### CROSS-REFERENCE TO RELATED APPLICATIONS

This application claims the benefit of priority from Japanese Patent Application No. 2022-197026, filed on Dec. 9, 2022, the entire contents of which is incorporated herein by reference.

### TECHNICAL FIELD

The present disclosure relates to a gaming machine, a gaming method, and a storage medium.

### BACKGROUND

Australian Patent Publication No. 2018236797 discloses a gaming machine that provides a slot game. The gaming machine spins and stops reels and provides an award when a symbol combination displayed as a game result has a winning combination. The symbol to be displayed includes a symbol associated with a credit value. When the symbol associated with the credit value is included in the winning combination, the gaming machine provides an amount related to the credit value as the award. When the first and second reels stop and display a wild symbol, the gaming machine expands the display areas of the third, fourth and fifth reels to be stopped subsequently.

### BRIEF SUMMARY OF THE INVENTION

The gaming machine described in Australian Patent Publication No. 2018236797 can generate a high-price win in a manner that is easily understandable. This is achieved when the third, fourth, and fifth reels stop and display the credit symbol with the high credit value, while the first and second reels stop and display the wild symbol. In such a gaming machine, a predetermined number of paylines (for example, 30 lines, 40 lines, 50 lines, or the like) are set, and symbols being stopped and displayed can form winning combinations in a plurality of paylines at the same time. However, there is room for improvement from the viewpoint of providing more attractive games to players.

An object of the present disclosure is to provide a gaming machine, a gaming method, and a storage medium capable of providing a novel game in which players are continuously stimulated in various modes.

A gaming machine according to an aspect of the present disclosure includes: an operation unit configured to receive an operation of a player; a display unit including a symbol display area and a payline display area, the symbol display area configured to display symbols in cells arranged in a grid and being set a plurality of paylines, each payline including a part of the cells, the payline display area configured to display a payline table indicating a part or all of the paylines; and a control unit connected to the operation unit and the display unit, configured to change and stop the symbols displayed in the symbol display area in response to receiving the operation of the player by the operation unit, and provide an award based on the symbols stopped in the cells forming the payline, wherein the control unit is configured to: set a chance area associated with an award booster to include a part of paylines indicated in the payline table, the award booster increasing the award; and increase the award using the award booster set in the chance area, the award provided based on the symbols stopped in the cells forming the payline included in the chance area.

According to another aspect of the present disclosure, there is provided a gaming method for providing a game using a gaming machine, the gaming machine including: an operation unit configured to receive an operation of a player; a display unit including a symbol display area and a payline display area, the symbol display area configured to display symbols in cells arranged in a grid and being set a plurality of paylines, each payline including a part of the cells, the payline display area configured to display a payline table indicating a part or all of the paylines; and a control unit connected to the operation unit and the display unit, configured to change and stop the symbols displayed in the symbol display area in response to receiving the operation of the player by the operation unit, and provide an award based on the symbols stopped in the cells forming the payline, the gaming method executed by the control unit, including: setting a chance area associated with an award booster to include a part of paylines indicated in the payline table, the award booster increasing the award; and increasing the award using the award booster set in the chance area, the award provided based on the symbols stopped in the cells forming the payline included in the chance area.

According to still another aspect of the present disclosure, there is provided a non-transitory computer-readable storage medium storing a program for a gaming machine providing a game to a player, the gaming machine including: an operation unit configured to receive an operation of a player; a display unit including a symbol display area and a payline display area, the symbol display area configured to display symbols in cells arranged in a grid and being set a plurality of paylines, each payline including a part of the cells, the payline display area configured to display a payline table indicating a part or all of the paylines; and a control unit connected to the operation unit and the display unit, configured to change and stop the symbols displayed in the symbol display area in response to receiving the operation of the player by the operation unit, and provide an award based on the symbols stopped in the cells forming the payline, the program configured to cause the control unit to: set a chance area associated with an award booster to include a part of paylines indicated in the payline table, the award booster increasing the award; and increase the award using the award booster set in the chance area, the award provided based on the symbols stopped in the cells forming the payline included in the chance area.

According to the present disclosure, there are provided a gaming machine, a gaming method, and a storage medium capable of providing a novel game that maintains or improves the interest of a player.

### BRIEF DESCRIPTION OF THE DRAWINGS

FIG. 1 is a perspective view illustrating an example of a gaming machine according to an embodiment.

FIG. 2 is a block diagram showing an example of the configuration of the gaming machine shown in FIG. 1.

FIG. 3 is a schematic diagram of a display area of the gaming machine of FIG. 1.

FIG. 4 is a diagram illustrating an example of a virtual reel set.

FIG. 5 is a diagram illustrating an example of symbols.

FIG. 6 is a diagram illustrating an example of paylines set in the display area of FIG. 3.

FIG. 7 is a diagram showing an example of a symbol display area and a payline display area before the start of the game.

FIG. 8 is a diagram illustrating an example of the symbol display area and the payline display area during providing the game.

FIG. 9 is a diagram illustrating an example of the symbol display area and the payline display area during providing the game.

FIG. 10 is a diagram illustrating an example of the symbol display area and the payline display area during providing the game.

FIG. 11 is a diagram illustrating an example of the symbol display area and the payline display area during providing the game.

FIG. 12 is a diagram illustrating an example of the symbol display area and the payline display area during providing the game.

FIG. 13 is a diagram illustrating an example of the symbol display area and the payline display area during providing the game.

FIG. 14 is a diagram illustrating an example of the symbol display area and the payline display area during providing the game.

FIG. 15 is a directory configuration diagram and a block diagram showing a program and data stored in the memory of FIG. 2.

FIG. 16 is a block diagram of a system for a gaming machine.

FIG. 17 is a block diagram of the game application program of FIG. 16.

FIG. 18 is a block diagram of the system application program shown in FIG. 16.

FIG. 19 is a flowchart for explaining the operation of a gaming machine.

### DETAILED DESCRIPTION OF EMBODIMENTS

Hereinafter, a gaming machine according to an embodiment will be described with reference to the accompanying drawings. In the drawings, the same or corresponding portions are denoted by the same reference numerals, and redundant description is omitted.

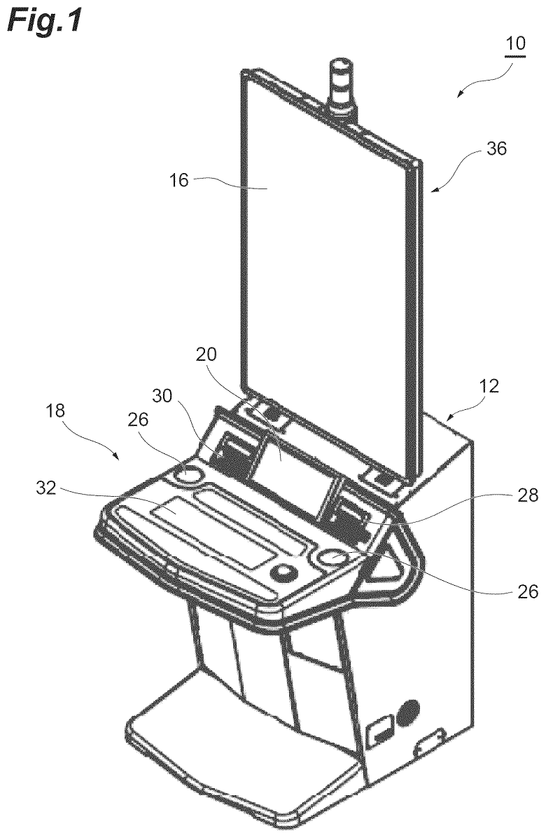

FIG. 1 is a perspective view illustrating an example of a gaming machine according to an embodiment. Here, the gaming machine is a device that receives a wager such as a cash, a medal, or a token from a player, starts a game, and pays a prize, an award, or a payout to the player according to a randomly determined game result. Such a gaming machine is designed and manufactured in accordance with local regulations, and is installed as a device in a licensed facility such as a casino after obtaining authorization by an authorization agency. A gaming machine 10 shown in FIG. 1 may receive a predetermined game value from the player, generate a game result, and provide a payout to the player in response to the game result and a pay table. The gaming machine 10 provides a video slot game as an example. The video slot game includes, for example, a normal game, a free game, and a feature game. The normal game, the free game, and the feature game are provided when a predetermined condition is satisfied. In the normal game, the free game, and the feature game, symbols displayed in the display area constitute a combination of symbols as a game result, and a winning is determined by the combination. In the feature game, a special condition related to a rule of the game (hereinafter referred to as a feature function) is provided, and the game is provided in a state where the feature function is exhibited. In other words, in the present embodiment, while the base game or the free game is being provided, the feature function is activated as described later, so that the game being provided becomes the feature game.

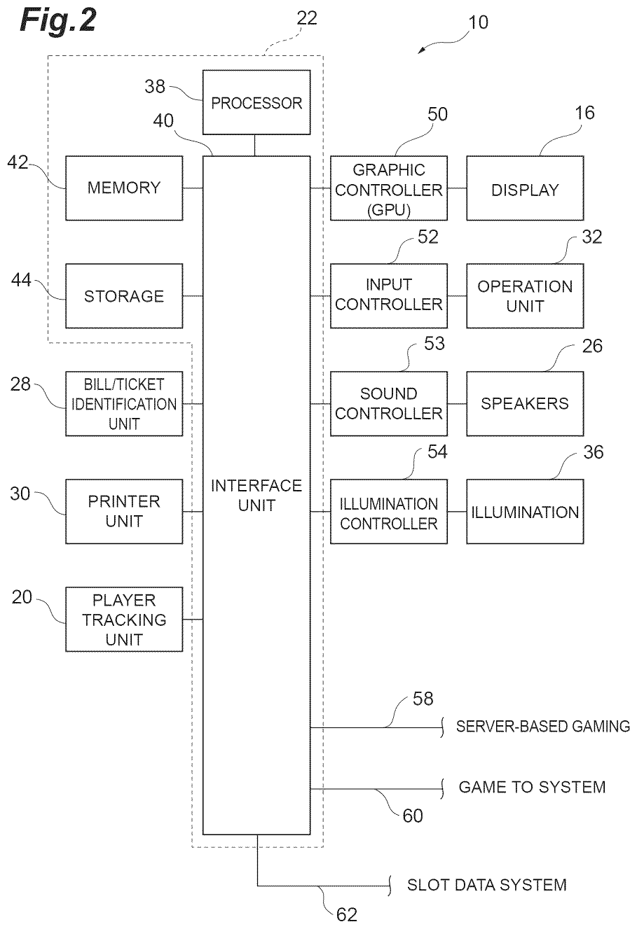

As shown in FIG. 1, the gaming machine 10 includes a display 16 (an example of a display unit) and a cabinet 12. The cabinet 12 also houses a control unit 22 (see FIG. 2) for controlling the components of the gaming machine 10.

The display 16 is a flat panel display device such as a liquid crystal display device or an organic EL display device. The display 16 is controlled via the control unit 22 to provide a game screen to the player. An illumination 36 may be provided around the display 16 to provide decorative lighting.

The cabinet 12 is disposed below the display 16. A control panel 18 is provided on the front surface of the cabinet 12 so as to project forward. The control panel 18 is provided with a player tracking unit 20, speakers 26, a bill/ticket identification unit 28, a printer unit 30, and an operation unit 32.

The player tracking unit 20 includes a card reader for recognizing a player identification card, a display for presenting a data to the player, and a keypad for receiving input by the player. The player tracking unit 20 cooperates with the control unit 22 or an external system to read information recorded on the player identification card inserted into the card reader by the player and display the information and/or information acquired by communicating with the external system on a display. Furthermore, input from the player is received by the keypad, the display is changed according to the input, and communication with an external system is performed as necessary.

The speakers 26 are provided on the left and right of the control panel 18. The speakers 26 are controlled via the control unit 22 to provide sound to the player.

The bill/ticket identification unit 28 may be housed in the cabinet 12 with the insertion opening exposed through which the bill/ticket is inserted. An identification part for identifying bill/ticket by various sensors is provided inside the insertion port. A bill/ticket storage part is provided on the output side of the identification part. The bill/ticket identification unit 28 accepts bill/tickets (including vouchers and coupons) that are the gaming value, identifies them as the gaming value, and notifies the control unit 22.

The printer unit 30 may be accommodated in the cabinet 12 in a state where a ticket output port through which the ticket is output is exposed. A printing part for printing predetermined information on a printing paper is provided inside the ticket output port, and a housing part for housing the printing paper is provided on the paper inlet side of the printing part. The printer unit 30, under control of the control unit 22, prints information on paper and outputs a ticket from the gaming machine 10 according to credit payout processing. The output ticket may be inserted into the bill/ticket identification unit 28 of another gaming machine to use the payout credit for game play, or may be exchange for cash by a kiosk terminal inside of the casino or casino cage.

The operation unit 32 receives an operation of the player. The operation unit 32 includes a group of buttons for receiving various instructions from the player on the gaming machine 10. The operation unit 32, for example, may include a group of a spin button and setting buttons. The spin button receives an instruction to start an instance of a game (start rotation of reel). The group of setting buttons includes a group of line-designation buttons, a group of bet buttons, a cash-out button and the like. The group of bet buttons receives an instruction operation related to a credit amount of a bet (bet amount) from a player. The cash-out button receives an instruction operation for instructing payout of credit accumulated in the gaming machine 10.

FIG. 2 is a block diagram illustrating an example of the configuration of a gaming machine. The gaming machine 10 includes the control unit 22. The control unit 22 includes a central processing unit (CPU) 38 including a processor constituting the control unit 22, an interface unit 40, a memory 42, a storage 44, and the like. The control unit 22 may be housed inside the cabinet 12 as a control board. The control unit 22 is configured to be able to communicate with each unit via the interface unit 40, and controls the operation of each unit by executing a program recorded in the memory 42 and/or the storage 44 of CPU 38 to provide a game to the player.

The interface unit 40 includes a chipset that provides communication functions of CPU 38, such as a memory bus connected to the CPU 38, various expansion buses, a serial interface, a universal serial bus (USB) interface, an Ethernet interface (registered trademark) and the like.

The memory 42 may include a random-access memory (RAM) that is a volatile storage medium, a read only memory (ROM) that is a nonvolatile storage medium, and an electrically erasable programmable read-only memory (EEPROM) that is a rewritable nonvolatile storage medium. The storage 44 provides the control unit 22 with a function as an external storage device, and can use a reading device such as a memory card and a magneto-optical disk which are removable storage media, and can also use a hard disk.

The bill/ticket identification unit 28, the printer unit 30, a player tracking unit 20, a graphic controller (GPU: Graphics Processing Unit) 50, an input controller 52, a sound controller 53, and an illumination controller 54 are connected to the interface unit 40. The graphic controller 50, the input controller 52, the sound controller 53, and the illumination controller 54 may be housed inside cabinet 12 as control boards.

The control unit 22 is connected to the display 16 via the graphic controller 50. The control unit 22 is connected to the operation unit 32 via the input controller 52. The control unit 22 is connected to the illumination 36 via the illumination controller 54.

The control unit 22 controls each unit by executing programs stored in the memory 42 and the storage 44, and provides the game to the player. Here, for example, the program and data of the operating system and subsystem providing basic functions of the control unit 22 may be stored in the EEPROM of the memory 42, and the program and data of the application providing the game may be stored in the storage 44. According to such a configuration, the game can be easily changed or updated by exchanging the storage 44. Furthermore, the control unit 22 may have a multiprocessor configuration including a plurality of CPUs.

Hereinafter, each block connected to the control unit 22 will be described. The bill/ticket identification unit 28 accepts the bill/ticket at the insertion port and notifies the control unit 22 of identification information corresponding to the assortment of bills or payout processing of credit. The control unit 22 increases the credit amount usable in the game according to the notified contents. The printer unit 30 prints information corresponding to payout processing of credit from the gaming machine 10 on a ticket and output under the control of the control unit 22 which receives the operation of a cash-out button included in the operation unit 32.

The player tracking unit 20 cooperates with the control unit 22 to transmit and receive player information and the like to and from the casino management system. The graphic controller 50 controls the display 16 under control of the control unit 22 to display a display image including various graphics data. The sound controller 53 drives the speakers 26 under the control of the control unit 22 to provide various sounds such as announcements, sound effects, BGM and the like. The illumination controller 54 performs lighting control of the illumination 36 under the control of the control unit 22.

The interface unit 40 includes various communication interfaces for communicating with the exterior of the gaming machine 10. The interface unit 40 may communicate with external networks by Ethernet 58, 60 and a serial interface 62, as examples. FIG. 2 shows an example of communication with other the gaming machine 10, a known server-side gaming network (Server-Based gaming), a G2S network (Game to system), and a slot information system (Slot Data System).

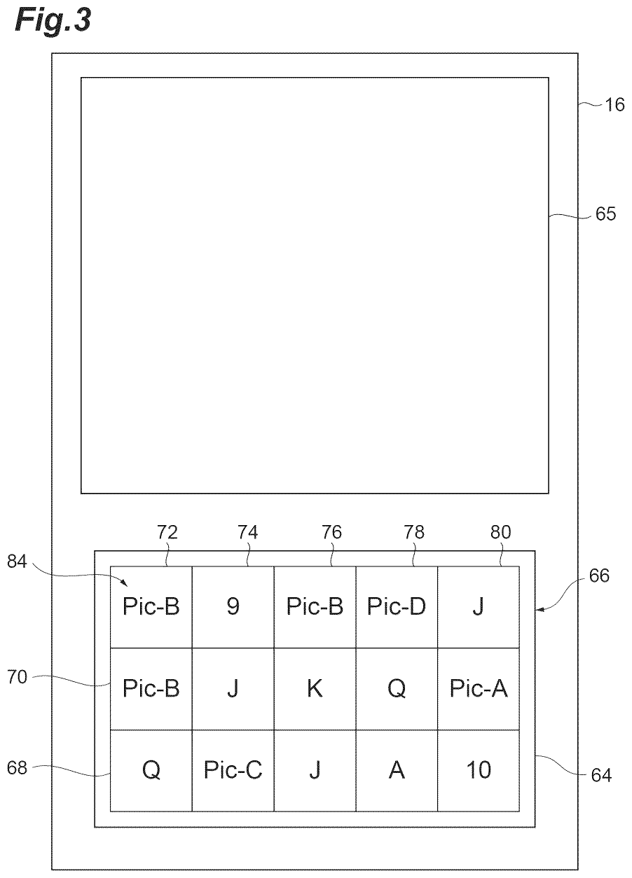

FIG. 3 is a diagrammatic illustration of a display area of the gaming machine in FIG. 1. As shown in FIG. 3, a game screen having a symbol display area 64 for displaying a slot game and a payline display area 65 displaying a screen related to a feature game is displayed on the display 16 by the control unit 22 executing a predetermined program. The symbol display area 64 is displayed in a lower region of the game screen. The payline display area 65 is provided in parallel with the symbol display area 64, and is displayed in an upper region of the game screen as an example. an area below the game screen as an example.

The symbol display area 64 includes a grid 68 capable of displaying symbols. By using such a display area, the gaming machine 10 operates as a slot machine that performs a winning determination according to a combination of symbols displayed on the grid 68 in the symbol display area 64 and provides a payout.

The display 16 displays a plurality of symbols in the grid 68. The grid 68 includes a plurality of rows and columns. The grid 68 is constituted by a plurality of a cell 70 which are stop positions of symbols. FIG. 3 illustrates a game screen including a plurality of cells arranged in a 5×3 grid pattern. The number of columns and the number of rows of the grid are not particularly limited, and may be another configuration such as 5×4, 3-4-4-4-3, 6×3, 6×4, or 3-3-3-5-5, or may be a configuration that increases or decreases according to the game development and/or the bet amount. One symbol is stopped and displayed on each of a plurality of the cell 70 in the symbol display area 64.

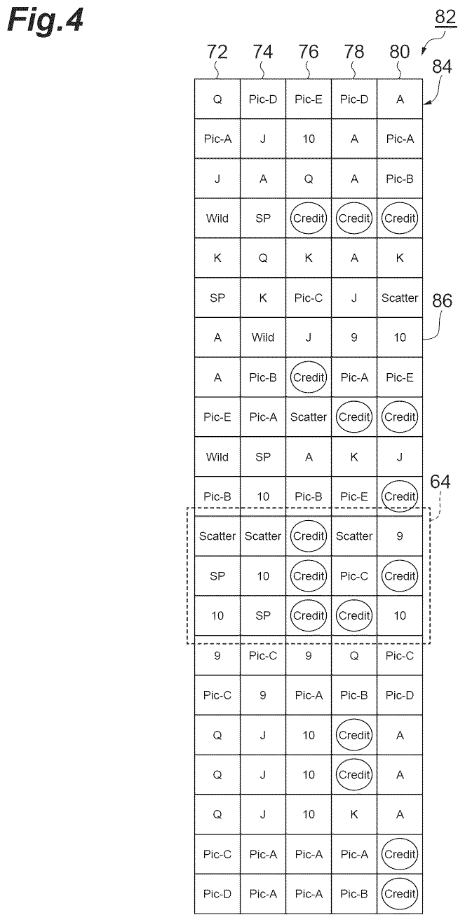

The symbol arranged in each of the plurality of cells 70 is determined by using, for example, a virtual reel strip for displaying a virtual reel 66. FIG. 4 is figure showing a virtual reel set. The virtual reel set includes a plurality of virtual reel strips, and the virtual reel strip includes symbol arrangements indicating the order of symbols displayed in the display area. As shown in FIG. 4, on each the cells 70 of the grid 68, symbols are displayed based on symbol arrangements of the virtual reel 66 including a virtual reel strips 72, 74, 76, 78, and 80 which form a virtual reel set 82. That is, the cells 70 of the grid 68 correspond to the virtual reel strips 72 to 80 by column, and the symbols arranged in predetermined parts of each virtual reel strips 72 to 80 are displayed. Furthermore, by moving (scrolling or spinning) each symbol by column based on the symbol arrangement of the virtual reel strips 72 to 80, the symbols displayed in the cells 70 of the grid 68 change, and by stopping the movement (scrolling or spinning) by columns, the symbols are stopped. Here, the virtual reel strips 72 to 80 are data where the control unit 22 uses a program having the memory 42 or the storage 44, and data showing the symbol arrangement (i.e., the order of symbols on each reel) regulated by each cell column. The virtual reel set 82 is a general term for such virtual reel strips 72 to 80.

The virtual reel strips 72 to 80 illustrated in FIG. 4 are constituted by symbols in each symbol position 86, and these symbols are arranged in an order defined for each reel. The number of symbols forming the virtual reel strips 72 to 80 is not limited thereto, and may be a desired number. The number of symbols forming the virtual reel strips 72 to 80 may be the same or may be different from each other.

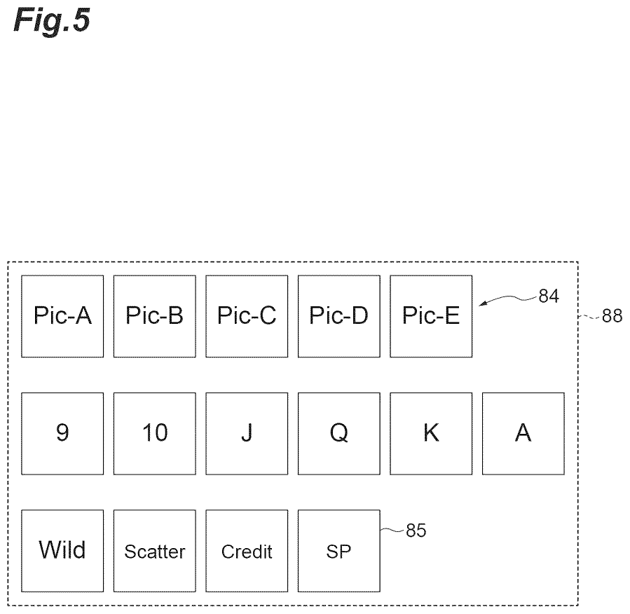

FIG. 5 is a detail of the symbols 84 shown in FIG. 4. Each of the virtual reel strips 72 to 80 includes symbols selected from a symbol set 88 of various the symbol 84 shown in FIG. 5. The symbol set 88 includes card symbols (“9”, “10”, “J”, “Q”, “K”, and “A”) imitating playing cards as regular symbols, and picture symbols (“Pic-A”, “Pic-B”, “Pic-C”, “Pic-D”, and “Pic-E”) indicating a pattern.

The symbol set 88 includes a wild symbol (“Wild”) that is substituted as another symbol when a winning combination is determined, a scatter symbol (“Scatter”) that triggers a free game in response to the appearance of a predetermined number of symbols when a winning combination is determined, a credit symbol (“Credit”) to which a predetermined credit value is provided at the time of winning, and a special symbol 85 (“SP”). The symbol set 88 may include a plurality of wild symbols, scatter symbols, credit symbols, and/or special symbols 85.

Since the credit symbol urges the player to directly understand the credit that can be acquired and to directly understand the chance by the appearance of the credit symbol with which the high credit is associated, the player's interest can be maintained or improved. The credit symbol can be, for example, a predetermined picture symbol such as coin on which the associated credit amount is displayed. Furthermore, the credit amount may not be displayed on the credit symbol while the symbol is changed, and the credit amount may be displayed after the symbol is stopped, or the credit amount may be displayed when winning occurs after the symbol is stopped.

The special symbol 85 is used as a start condition of the feature game, that is, an activation condition of the feature function. As an example, the activation condition of the feature function is satisfied when a wild symbol or the special symbol 85 is displayed on each of the first reel and the second reel in the symbol display area 64 by the virtual reel strip 72 and a virtual reel strip 74.

A plurality of virtual reel sets may be prepared according to the game content. For example, the virtual reel set used in the normal game may be different from the virtual reel set used in the free game or the feature game. The virtual reel set in the free game may include more picture symbols, wild symbols or scatter symbols than the virtual reel set in the normal game. It is possible to increase the winning probability or the trigger probability during the free game, and it is possible to provide the player with a valuable free game. The virtual reel set in the feature game may include more the special symbols 85 or credit symbols than the virtual reel set in the normal game. In this way, the probability of bonus winning in the feature game can be increased. Here, the “trigger of the feature game or free game” means an “opportunity to acquire the feature game or free game”, and the “trigger symbol” means a “symbol serving as an opportunity to acquire the feature game or free game”. Alternatively, the virtual reel set to be used may be switched based on a random number.

Further, although FIG. 4 shows an example where any symbol is fixedly arranged in each symbol position 86 of the virtual reel strips 72 to 80 forming the virtual reel 66, the symbols arranged in symbol positions 86 may be dynamically determined. For example, symbols arranged in a part of the symbol positions 86 may be randomly determined by a random number, and in this case, a predetermined type of the same symbols randomly determined may be arranged in a plurality of the symbol positions 86. Furthermore, a plurality of groups of the symbol positions 86 in which the same symbols are arranged may be provided, and symbols randomly determined for each group may be arranged, or symbols may be dynamically arranged for all the symbol positions 86.

The control unit 22 starts the game and randomly determines the stopping position of each of the virtual reel strips 72 to 80. The virtual reel strips 72 to 80 displayed on the display 16 moves (scrolls or spins) from the current position and stops based on the stopping position to represent the game result. Therefore, in the display 16 or the grid 68, the symbols included in the virtual reel strips 72 to 80 fluctuate in accordance with continuous movement (scrolling or spinning) of the virtual reel strips 72 to 80 in the vertical direction of the symbol display area 64, and are displayed such that one symbol is stopped in one cell 70 according to the order of the symbols defined in the virtual reel strips 72 to 80.

The control unit 22 may be configured to change a plurality of symbols displayed on the display 16 by the above-described method in accordance with the operation of the player received by the operation unit 32, stop the symbols in a predetermined order, and provide a payout in accordance with the symbols stopped in the symbol display area 64.

Paylines are set for the symbol display area 64. Each of the paylines consists of a part of the cells, and a plurality of paylines is set in the symbol display area 64. For example, payline is set so as to cross the symbol display area 64 from cell in the leftmost column to the rightmost column. An example of the payline can be composed of any cell in the leftmost column, any cell in the second column from the left, any cell in the third column from the left, any cell in the fourth column from the left, and any cell in the fifth column from the left (rightmost column). In the 5×3 matrix, 243 (3 to the 5th power) types of paylines can be set, however, 40 types or 50 types of paylines may be set. With respect to the game result which is a combination of symbols, the control unit 22 determines winning when the identical or similar (same type of) symbols are aligned on a payline in excess of a predetermined number, and provides a payout to the player in accordance with the type and number of symbols. Further, the payline may be set so as to cross the symbol display area 64 from the cell of the upper end row toward the cell of the lower end row, or the payline may be configured by cells arranged in a predetermined shape such as a triangle or a rectangle, or a character/symbol shape.

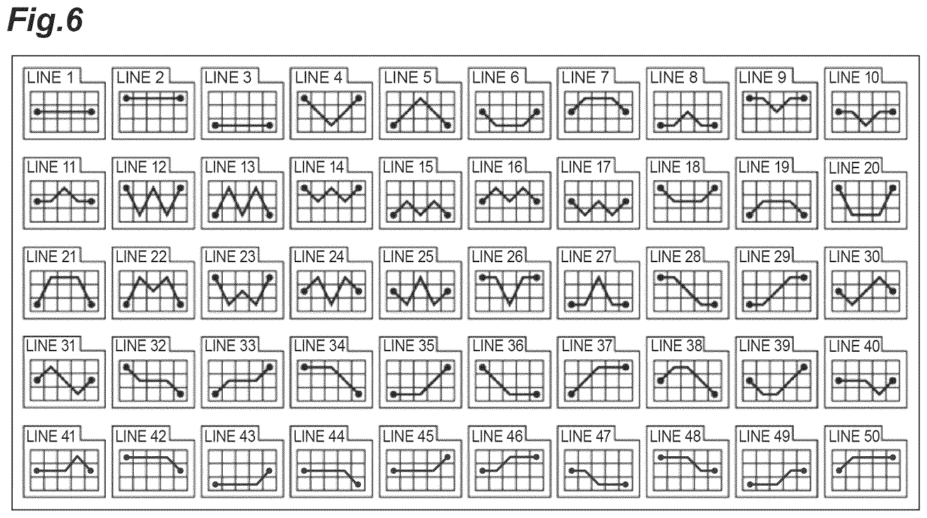

FIG. 6 is a diagram showing an example of paylines set in the symbol display area 64 of FIG. 3. As shown in FIG. 6, in the gaming machine 10, a predetermined number of paylines (50 patterns of lines) are set in advance in cells of three rows and five columns in the symbol display area 64. The system for determining winning may determine winning when a predetermined number of same symbols are arranged from the cell of the leftmost column on the payline, may determine winning when a predetermined number of same symbols are arranged from the cell of the rightmost column on the payline, or may determine winning when a predetermined number of same symbols are arranged in consecutive columns on a predetermined payline regardless of whether the symbols are arranged from the left end or the right end. In addition, more than a predetermined number of scatter symbols form a winning combination or trigger condition regardless of paylines.

The control unit 22 causes the payline display area 65 to display a payline table indicating some or all of the paylines shown in FIG. 6. In the payline table, graphics images showing the paylines are displayed in a grid of cells arranged in rows and columns one by one. Thus, the player can proceed with the game while checking the payline. The control unit 22 may stop some symbols of the plurality of symbols in the symbol display area 64 and cause the payline display area 65 to display a payline that can be won by the symbols that have been stopped while changing the remaining symbols. For example, the control unit 22 may spin each of the first reel to the fifth reel, stop the first and second reels, and display the payline that can be won by symbols of the first and second reels when the third reel to the fifth reel are spinning. For example, the control unit 22 may spin each of the first reel to the fifth reel, stop the first, second and third reels, and display the payline won by the symbols of the first, second and third reels when the fourth and fifth reels are spinning. Such display of the winning payline may be performed by highlighting such as blinking or enlargement of the payline, addition of another image, animation processing, or the like in the payline table.

The gaming machine 10 according to the present embodiment provides three kinds of game, for example, normal game (also referred to as a main game, a base game, or a primary game) provided when a predetermined condition is not satisfied, and first and second special games provided when the predetermined condition is satisfied. The first special game is a free game, and a predetermined number of times of free games not consuming a game value are provided when a predetermined trigger condition is satisfied. The second special game is a feature game. When a predetermined trigger condition is satisfied during the providing the normal game or the first special game, a feature function described later is activated and a transition from the normal game or the first special game to the second special game occurs.

In the normal game, the first special game, and the second special game, symbols displayed in the symbol display area 64 among symbol arrangements configuring game results are subject to winning determination. That is, the control unit 22 that has started the game randomly determines a stopping position for each of the virtual reel strips 72 to 80 shown in FIG. 4, and expresses an animation in which the virtual reel strips 72 to 80 moves from the current position and stops at the stopping position using the display 16. Accordingly, in the symbol display area 64, the symbols arranged on the virtual reel strips 72 to 80 continuously move (scroll) in the vertical direction, and stop so that one symbol is displayed on one the cell 70 while maintaining continuity.

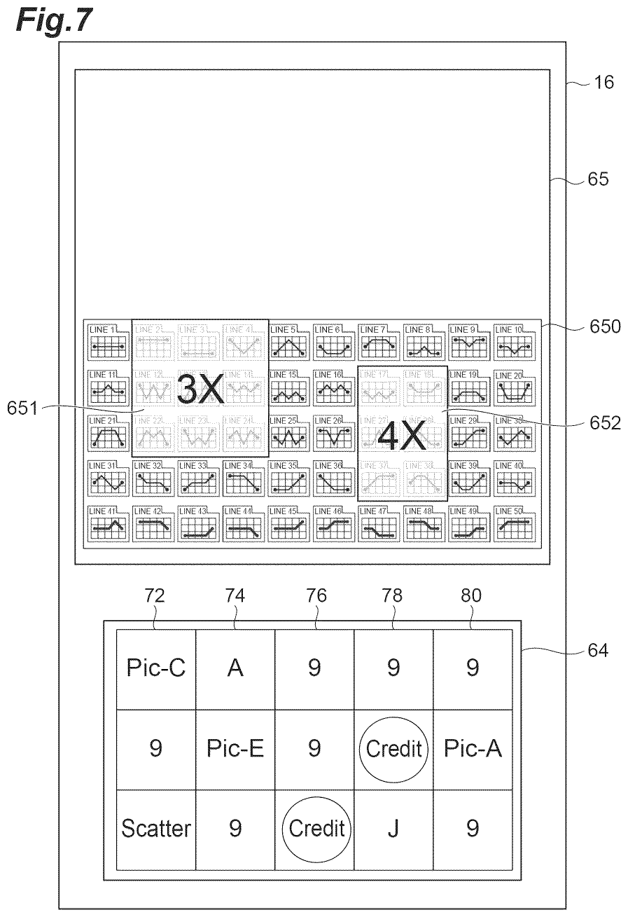

However, in the present embodiment, at the time of the feature game, the feature function described below is applied, and as a result, one or more chance areas are set so as to include some paylines indicated in the payline table. An award booster for increasing the award is set in each chance area. The award booster increases the award, which is provided based on the symbol stopped in the cell forming the payline, targeting the payline included in the corresponding chance area. In other words, each chance area is provided with a function of “award booster” which increases the award obtained by the paylines in the chance area. More specifically, for example, the award booster adds a bonus amount to the amount of the award to be awarded, the award booster applies a multiplier (value) to the amount of the award to be awarded, or the award booster changes winning content to more expensive winning content (for example, jackpot winning). The symbol display area 64 and the payline display area 65 applied in the feature game will be described below with reference to FIGS. 7 to 14.

FIG. 7 is a diagram showing an example of a symbol display area and a payline display area before the start of the game. As shown in FIG. 7, the symbol display area 64 and the payline display area 65 are set for the display 16. The control unit 22 displays the above-described a payline table 650 on the payline display area 65. As shown in the figure, the payline table 650 is displayed by arranging paylines set for the symbol display area 64 in a matrix form. All paylines may be displayed, or only some paylines may be displayed on the payline table 650. However, in the latter case, for paylines that are not displayed in the payline table 650, the benefit of the award booster cannot be obtained unless the paylines are separately set or the chance area is extended. There is no limitation on the arrangement of paylines in the payline table 650. And the paylines may be arranged in a predetermined order or may be arranged in a randomly determined order. The control unit 22 sets the first chance area 651 and the second chance area 652 in the payline table 650. The number of chance areas is arbitrary. The first chance area 651 and the second chance area 652 are overlay displayed on the payline table 650 in the display 16 as translucent graphical objects each having a predetermined shape. In other words, the chance areas are displayed over the payline table in a superimposed manner, and the player can see the paylines covered by the chance areas through translucent chance area. It is acceptable to display chance areas as semi-translucent graphical object.

The chance area includes one or more paylines. For example, in the example of FIG. 7, the first chance area 651 has a size that encompasses nine paylines, and the second chance area 652 has a size that encompasses six paylines. The chance area may be provided a multiplier value that is applied to an award occurred by the symbols stopped in cells forming the payline. For example, in the example of FIG. 7, a multiplier of 3× is provided as the award booster in the first chance area 651, and a multiplier of 4× is set as the award booster in the second chance area 652. As a result, for example, nine paylines included in the first chance area 651 are increased. For example, a multiplier of 3× is applied to the award provided based on the symbols stopped in the cells forming the payline. Similarly, for the six paylines included in the second chance area 652, a multiplier of 4× is applied to the award provided based on the symbols stopped in the cells forming these paylines. Note that the value of the multiplier of the award booster may be a predetermined value or a value randomly determined from a numerical value within a predetermined range. Before the start of the game, the control unit 22 does not stop the first chance area 651 and the second chance area 652 on the payline table 650, moves them slowly on the payline table 650 so as to indicate a state in which the payline to which the award booster is applied is not determined. In this case, movement may be performed while sequentially changing the size of the chance area, the contents of the award booster (for example, multiplier value), and the like.

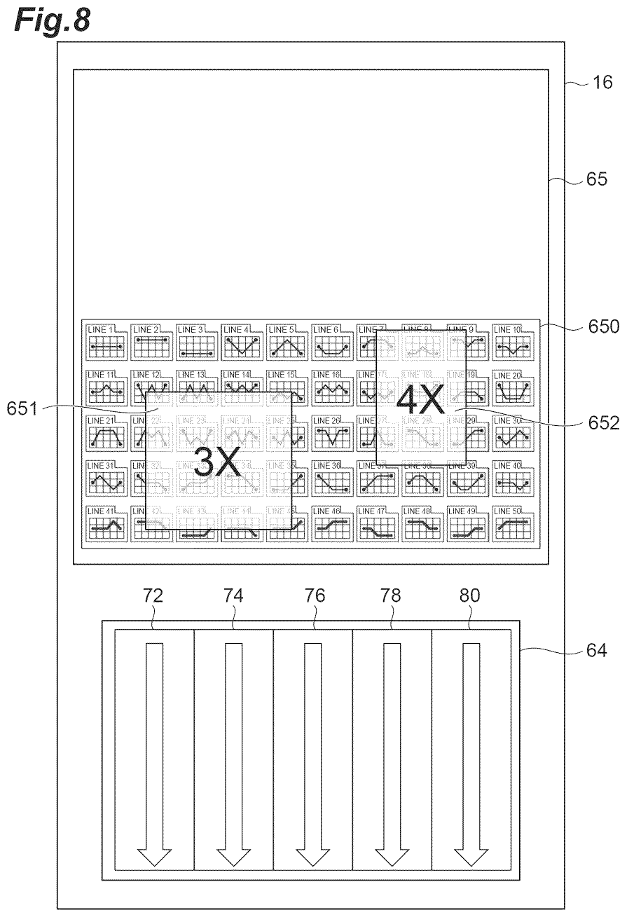

As shown in FIG. 8, when the game is started, the control unit 22 continuously moves (scrolls) the symbols arranged in the virtual reel strips 72 to 80 in the symbol display area 64 in the vertical direction. At this time, the control unit 22 causes the first chance area 651 and the second chance area 652 to continue to move in the payline display area 65 without stopping on the payline table 650.

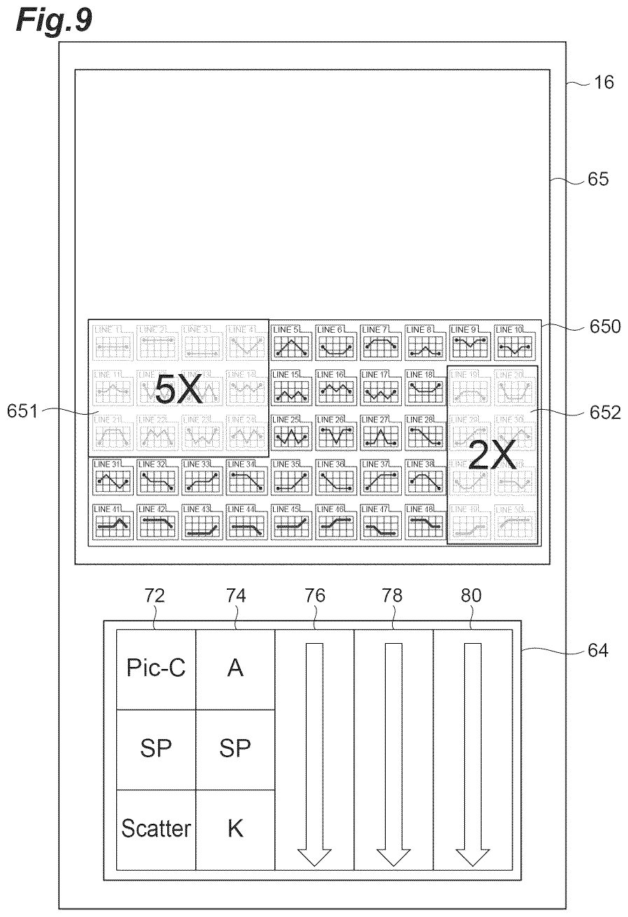

Next, FIG. 9 shows a state where the special symbol 85, indicated as “SP”, is displayed on each of the first and second reels when the first and second reels are stopped and the third to fifth reels continue to spin. In this case, the present game becomes a feature game, and the feature function is activated. In the feature game, an amount corresponding to a credit value associated with a credit symbol is provided as an award to a symbol array including the special symbol 85 and the credit symbol. For example, in a case where “SP”, “SP”, “100”, “100”, and “100” are arranged in order from the left, the winning amount becomes the total value and becomes “300”. Further, in the feature game, the winning amount according to the symbol arrangement may be increased by the award booster described above. The control unit 22 sets a size and an arrangement position of the chance area and a corresponding award booster, used in the feature game. When the feature game is triggered, the control unit 22 fixedly displays the set chance area on the payline display area 65. For example, as shown in FIG. 9, the first chance area 651 has a size including twelve paylines, is set to the upper left portion of the payline table 650 with a multiplier of 5×. Similarly, the second chance area 652 has a size including eight paylines, is set to the right portion of the payline table 650 with a multiplier of 2×. In this way, after changing the symbols is started, the position of the chance area and the contents of the award booster are displayed in the payline display area 65. Note that the control unit 22 may set the chance area at a fixed position of the payline table 650 or may set the chance area at a randomly determined position of the payline table 650.

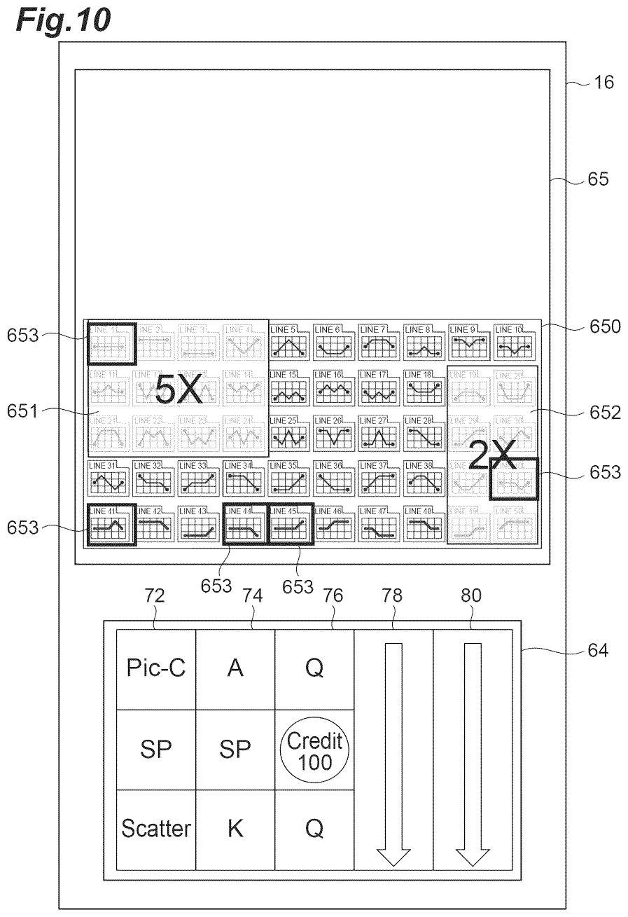

Next, as shown in FIG. 10, when the third reel is stopped, the control unit 22 highlights the payline won by the symbols of the first, second and third reels in the payline display area 65. The control unit 22 emphasizes the winning payline by surrounding it with a display frame 653, for example. In FIG. 10, an example in which each of five paylines is surrounded by the display frame 653 is illustrated. Thus, the player can visually confirm the winning payline. In the example illustrated in FIG. 10, one payline included in the first chance area 651 is highlighted, and one payline included in the second chance area 652 is highlighted. As a result, the player can easily understand that there is a possibility that the winning payline could further increase in value. In addition, the player can easily understand that the multiplier of 5× is applied when a payline included in the first chance area 651 is won and the multiplier of 2× is applied when a payline included in the second chance area 652 is won. Therefore, it is easy to visually recognize which payline is in an advantageous state. The control unit 22 may highlight the winning payline by changing the saturation, brightness, or the like of the display color.

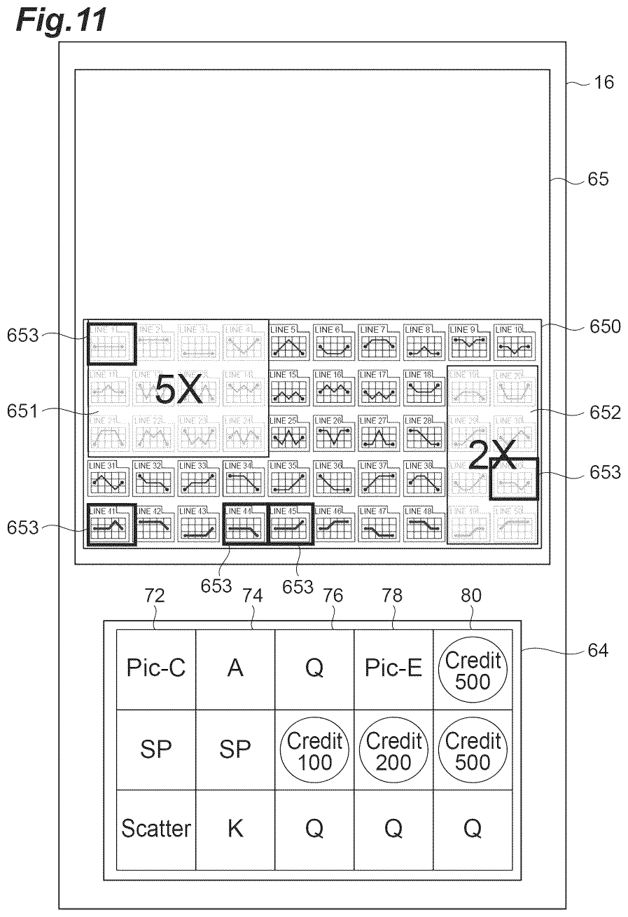

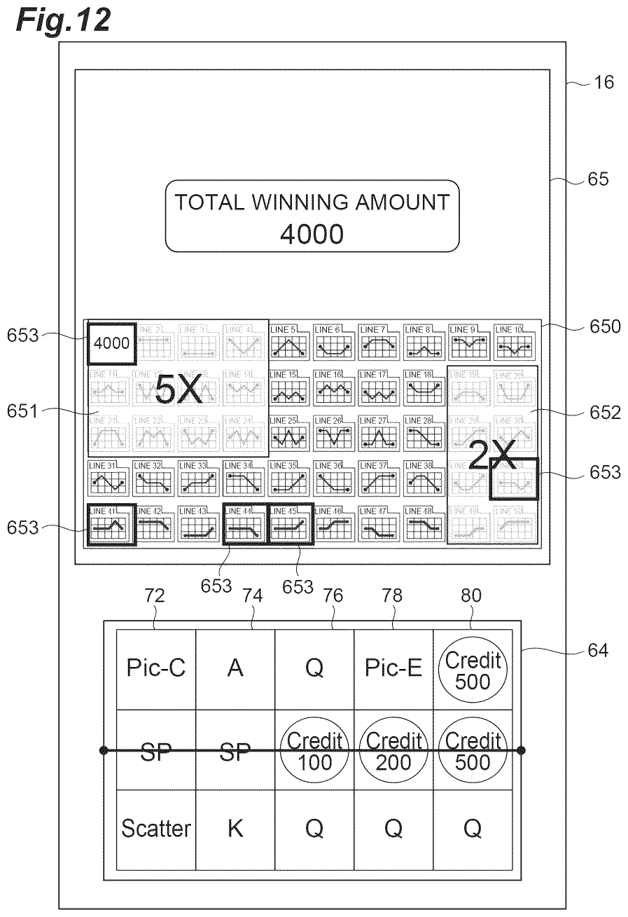

Next, all the reels are stopped as shown in FIG. 11. Thereafter, the control unit 22 displays the total winning amount. The control unit 22 may calculate and display a winning amount for each winning payline. As shown in FIG. 12, the control unit 22 displays the winning amount of the winning payline in the display frame 653. In the payline of the middle cells illustrated in FIG. 12, since the symbol arrangement is “SP”, “SP”, “100”, “200”, and “500”, the winning amount is “800”. Further, since the payline of the cells in the middle row shown in FIG. 12 is included in the first chance area 651, the award booster corresponding to the first chance area 651 applies the multiplier of 5× to the payline to obtain a winning amount “4000”, and the winning amount “4000” is displayed in the display frame 653. The control unit 22 adds the calculated winning amount of the payline to the total winning amount and displays the sum. As a result, the total winning amount “4000” is displayed.

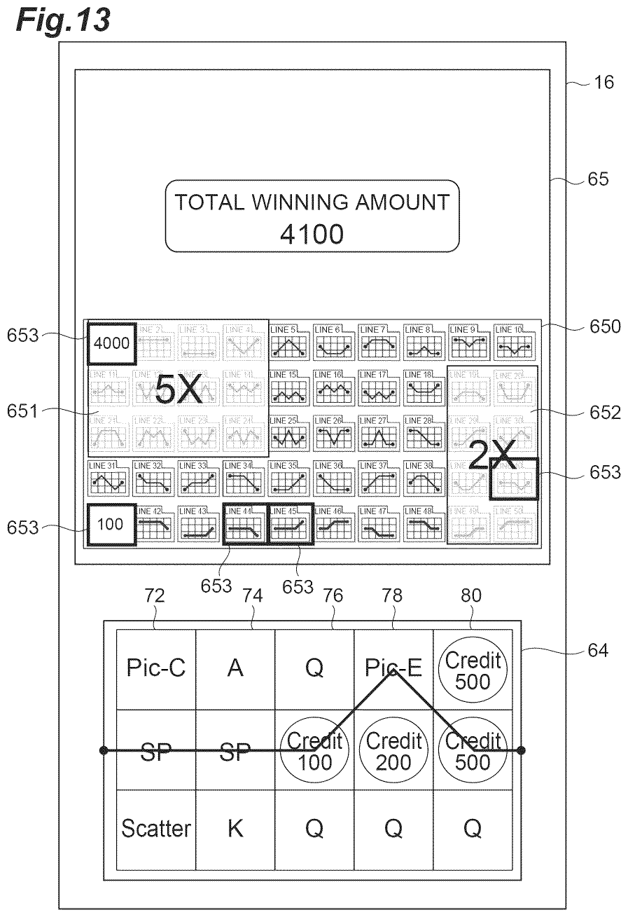

As shown in FIG. 13, the control unit 22 calculates a winning amount for another payline that has been won. In the payline illustrated in FIG. 13, since the symbol arrangement is “SP”, “SP”, “100”, “Pic-E”, and “500”, the winning amount is “100”. Since the payline shown in FIG. 13 is included in neither the first chance area 651 nor the second chance area 652, there is no increase by the award booster, the winning amount becomes “100”, and the winning amount “100” is displayed in the display frame 653. Then, the total winning amount “4100” is displayed.

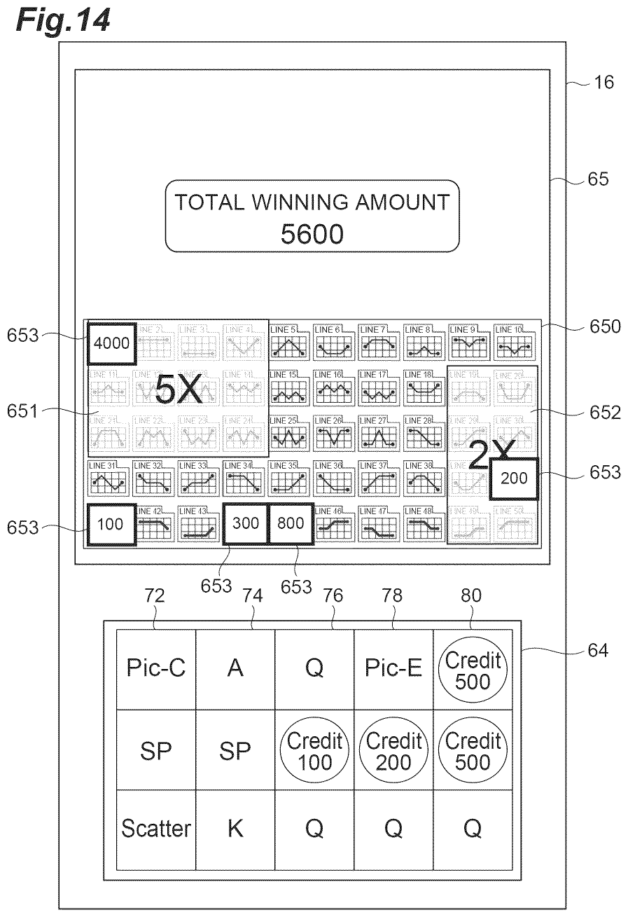

The control unit 22 performs the above-described processing with respect to all the winning paylines. As a result, as shown in FIG. 14, the winning amount for each winning payline and the total winning amount are displayed.

Note that the control unit 22 may be set for each game that is started by changing symbols and ended by stopping the symbols and providing an award based on the symbol stopped in cells forming a payline, or may be set each time the game is executed a predetermined number of times. That is, the setting of the chance area may be updated every game, or may be updated every predetermined number of times.

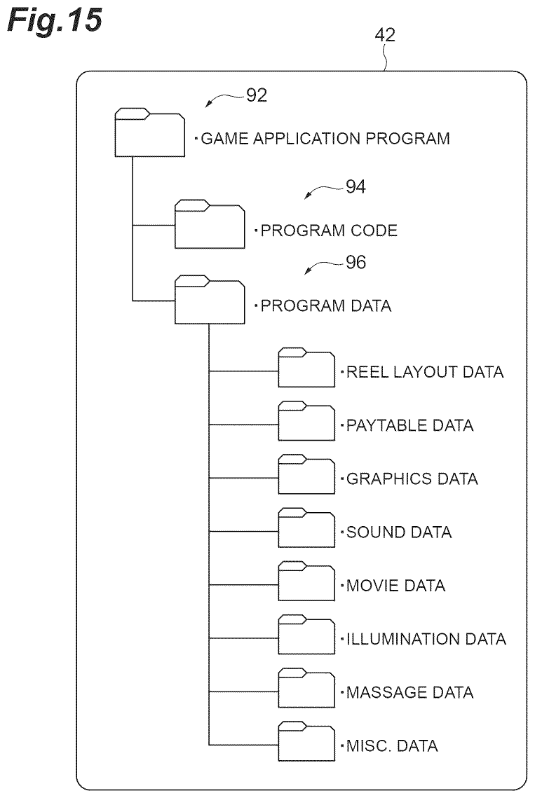

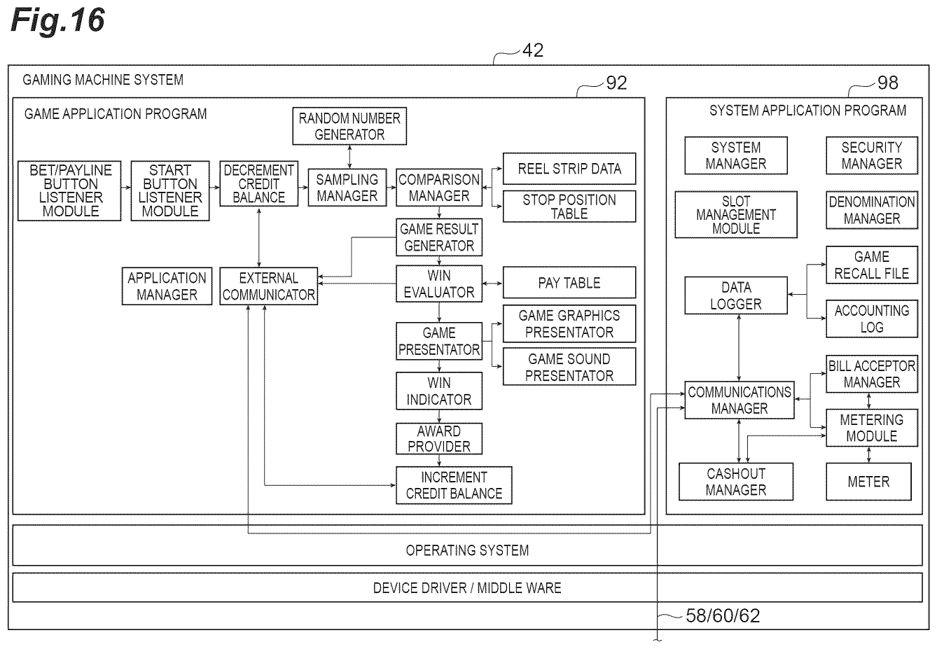

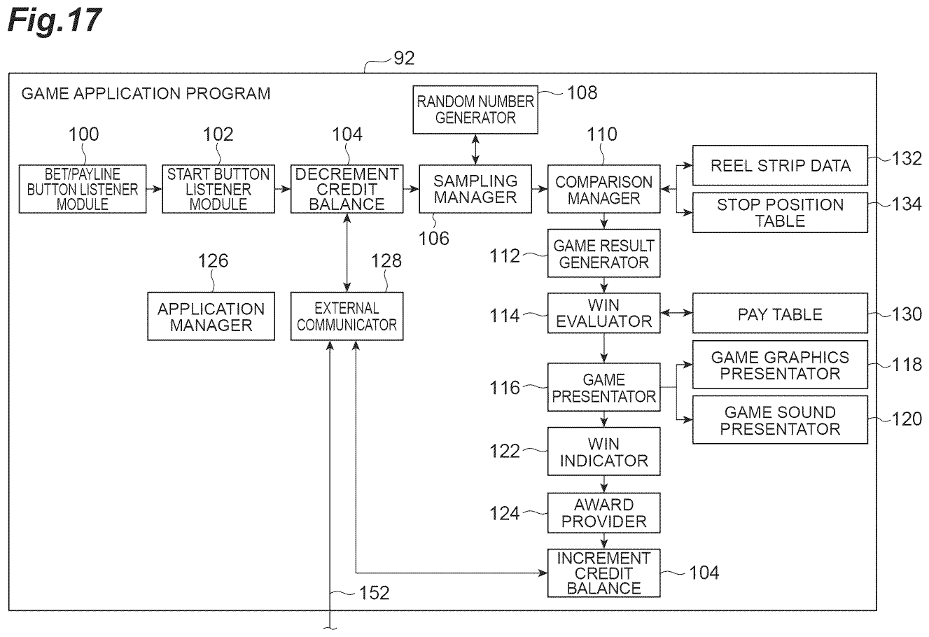

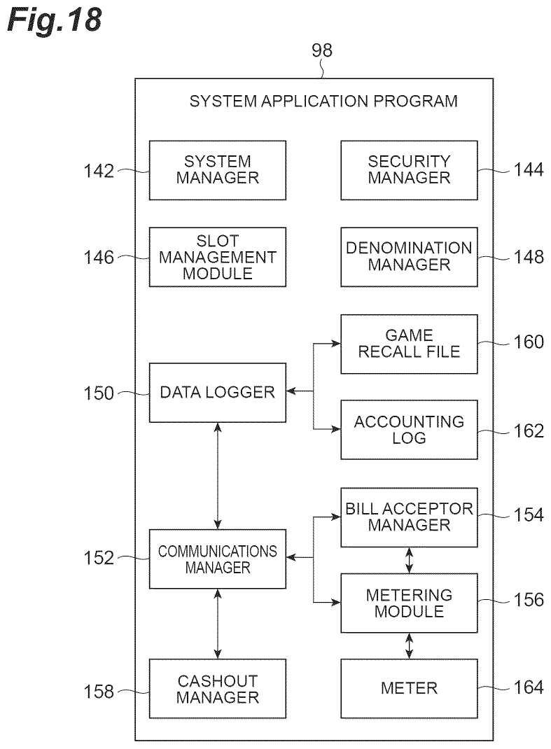

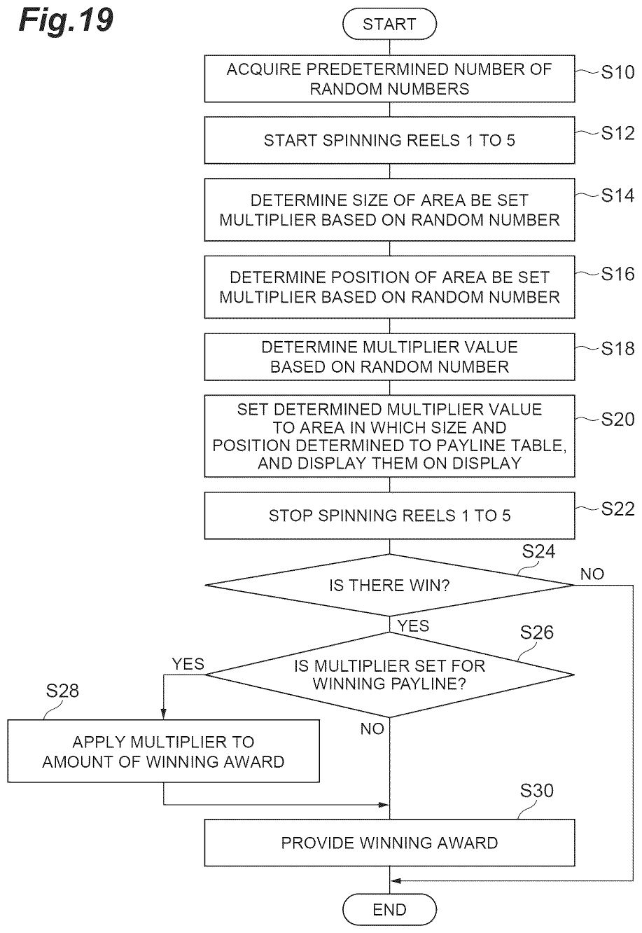

FIGS. 15 and 16 are a directory configuration diagram and a block diagram showing a program and data stored in the memory of FIG. 2. FIG. 17 is a block diagram of the game application program of FIG. 16. FIG. 18 is a block diagram of the system application program shown in FIG. 16. In the embodiments shown in FIGS. 15 to 18, the memory 42 stores a game application program 92 including computer-executable instructions, and processing of the game is performed by executing these computer-executable instructions in CPU 38, and the game screen is displayed on the display 16 in the gaming machine 10. Also, in one embodiment, the game application program 92 includes a program code 94 and a program object data 96 that includes computer-executable instructions for implementing a game using the algorithms shown in FIG. 19.

In an exemplary embodiment, the memory 42 stores the game application program 92 and a system application program 98 including computer-executable instructions that are executed in the CPU 38 to process the game and display a game screen on the display 16 of the gaming machine 10. The game application program 92 provides a game specific/front-end function by executing on the CPU, and the system application program 98 provides a generic/back-end function. In the illustrated embodiment, the game application program 92 and the system application program 98 are implemented on the same operating system. However, it should be noted that these programs may be implemented on different operating system and/or by different processors.

In one embodiment, the game application program 92 includes a plurality of software modules including a bet/payline button listener module 100, a start button listener module 102, a credit balance manager module 104, a sampling manager 106, random number generator (RNG) 108, a comparison manager 110, a game result generator 112, a win evaluator 114, a game presentator 116, a game graphics presentator 118, a game sound presentator 120, a win indicator 122, an award provider 124, an application manager 126, and an external communicator 128. The game application program 92 may also include a pay table 130, a reel strip data 132, and a stop position table 134.

The bet/payline button listener module 100 is a software module for receiving a signal from a bet button 34 or a line-designation button 33 of the operation unit 32, the signal is generated by buttons when the player operates the buttons to select bet amount or the number of paylines to activate. In response to receiving the signal, the bet/payline button listener module 100 communicates the occurrence of the signal to the application manager 126 for changing the configuration of the activated payline or betting the game.

The start button listener module 102 is a software module for receiving a signal from a start button, which is generated when the player operates the button to start a game. In response to receiving the signal, the start button listener module 102 communicates the occurrence of the signal to the application manager 126 to initiate the game.

In response to receiving a signal from the start button listener module 102, the application manager 126 requests the sampling manager 106 to obtain the required number of random numbers from the random number generator 108.

The random number generator 108 is a software module for generating random numbers based on predetermined algorithm of computational random generation method. The random number generator 108 may be a pseudorandom generator. The random number generator 108 returns the random numbers in response to a request from the sampling manager 106. The random number generator 108 may be implemented in part or in whole as integrated circuits or wired logic.

The comparison manager 110 compares the current state of the game and/or each random number with the reel strip data 132 and the stop position table 134, and specifies the stopping position of the corresponding reel strip based on each random number.

The reel strip data 132 has virtual reel strips for normal games, free games, and special games. The comparison manager 110 described above queries the application manager 126 to identify the current state of the game and selects virtual reel strips.

The stop position table 134 includes a range of random numbers associated with each stopping position of the virtual reel strip. The comparison manager 110 determines the stopping position of each reel based on the corresponding random number and the stop position table 134.

The game result generator 112 generates a game result based on the selected reel layout, the stopping position of each reel, the stopping position of the inner symbol, and the attribute to be added. In one embodiment, the game result generator 112 may apply a modification on the game result when a predetermined condition is satisfied.

The win evaluator 114 evaluates the game result with reference to the pay table 130. To be specific, the winning evaluation is performed based on whether symbols defined as a winning combination in the pay table 130 stops on the payline in the symbol display area 64.

The game presentator 116 utilizes the game graphics presentator 118 and the game sound presentator 120 to provide a game presentation process consisting of video animation and sound to eventually form a predetermined game result.

The game sound presentator 120 provides a sound presentation process by using the sound controller 53 and speakers 26. The win indicator 122 indicates a winning combination and a payment condition of prize symbols formed in the game result. The award provider 124 provides award credit to the win meter based on the win evaluation.

The application manager 126 administrates the operation and state of each software module. In addition, the application manager 126 administrates the configuration, progress and states of the game application program 92. The application manager 126 refers to a gaming state storage unit 127, determines the size of the symbol display area 64 based on the stored game state, and provides the game. The external communicator 128 communicates instructions and data with the system application program 98.

The credit balance manager module 104 executes a process for decrementing the credit balance according to the bet amount and incrementing the credit balance based on the total amount of winnings displayed on the winning meter. The pay table 130 includes a payout amount or award amount associated with each winning combination.

In an exemplary embodiment, the system application program 98 provides back ground processing and functions other than game specific functions. The system application program 98 includes a plurality of software modules including a system manager 142, a security manager 144, a slot management module 146, a denomination manager 148, a data logger 150, a communications manager 152, a bill acceptor manager 154, a metering module 156, and a cashout manager 158.

The system application program 98 may include a game recall file 160, an accounting log 162, and a meter 164. The system manager 142 is a software module for administrating all of the back-ground processing and functions other than game specific functions conducted by the system application program 98.

The security manager 144 is a software module for administrating game verification, door security and monitoring security sensors. The slot management module 146 is a software module for administrating data accumulation and communicating with an external slot information system.

The denomination manager 148 is a software module for establishing the denomination setting of the gaming machine 10. The denomination setting may include 1 cent, 2 cents, 5 cents, 25 cents, 1 dollar, 5 dollars and the like. The data logger 150 is a software module for logging the results of each game in a game recall. In addition, the data logger 150 stores error events, bill logs, cashout logs, ticket logs, and the like in an accounting log.

The game recall file 160 is an accumulated data including the results of each game. The game recall file 160 is stored in non-volatile memory. The accounting log 162 is an accumulated data including error events, bill logs, cashout logs, ticket logs and the like. The accounting log 162 is stored in non-volatile memory.

The communications manager 152 is a software module for administrating communication between the game application program 92 and the system application program 98. The communications manager 152 also administrates network communications between the system application program 98 and other the gaming machine 10, external network such as slot management system network, G2S network, gaming server for server-based gaming network or VLT system network.

The bill acceptor manager 154 is a software module for managing bill acceptors, and accepts bill information inserted in the bill acceptor. In response to receiving the information from the bill acceptor, the bill acceptor manager 154 communicates with the metering module to increment the credit balance based on the inserted bill.

The metering module 156 is a software module for adjusting the value of the meter 164 in response to communication with the game application program 92 via the communications manager 152, the bill acceptor manager 154 or the cashout manager 158. The meter 164 includes a credit meter to indicate the current credit balance of the gaming machine and a win meter to indicate the total amount of wins for the current gaming session. The meter further includes background meters, such as coin-in, coin-out, total drop, attendant paid jackpot and/or bill-in. These meters may be implemented as a data on non-volatile memory or hardware meters.

The cashout manager 158 is a software module for administrating a cashout procedure. In response to the player's operation on the cashout button, the cashout manager 158 is activated and the gaming machine pays the total amount of credit meters in cash or a voucher.

FIG. 19 is flowchart for explaining the operation of the gaming machine. The algorithm (gaming method) of the operation of the gaming machine is implemented in the game application program 92 and is embodied by the CPU38 executing the game application program 92. The operation of the gaming machine includes a plurality of steps. Each step may be performed independently or may be performed in combination with other steps.

In step S10, upon receiving a game start operation by the player and receiving an operation of the spin button from the player, the control unit 22 subtracts the set total bet amount from credit and acquires a predetermined number of random numbers required to provide the game. The random numbers are generated internally in the random number generator 108 in the control unit 22. The control unit 22 may acquire the random numbers from a random number generator provided separately from the control unit 22, or may acquire the random numbers from devices such as servers provided outside the gaming machine 10.

In step S12, the control unit 22 starts spinning of a plurality of reels. As a result, a plurality of symbols is displayed on the symbol display area 64, and the displayed symbols change.

In step S14, the control unit 22 determines the size of the chance area based on a random number. For example, by assigning the vertical and horizontal lengths of the chance area to each numerical range, the control unit 22 can determine the size of the chance area based on random numbers.

In step S16, the control unit 22 determines the position of the chance area based on a random number. For example, by assigning the position coordinates of the chance area to each numerical range, the control unit 22 can determine the position of the chance area based on a random number.

In step 18, the control unit 22 determines a value associated with the chance area based on a random number. For example, by assigning the value of the chance area to each numerical range, the control unit 22 can determine the value associated with the chance area based on a random number. Note that the order in which steps S14 to S18 are performed can be arbitrarily changed.

In step 20, the control unit 22 displays the chance area in which the size, the position, and the value determined in steps S14 to S18.

Next, in step S22, the control unit 22 stops the spinning of the plurality of reels. Thus, the symbol combination is displayed on the symbol display area 64 as a game result. The control unit 22 may execute step S20 in the middle of the stop in step S22 (for example, at the timing when the first and second reels are stopped).

In step S24, the control unit 22 determines whether the symbol combination displayed as the game result on the symbol display area 64 matches a winning combination. As an example, the control unit 22 determines a winning based on the symbol combination displayed in the symbol display area 64, the winning combination, and the set payline. When it is determined that there is a win (step S24: YES), the control unit 22 determines whether or not to apply value to the winning payline as step S26. The control unit 22 determines that the value is applied to the winning payline when the winning payline is included in the chance area, and determines that the value is not applied to the winning payline when the winning payline is not included in the chance area.

When it is determined that the value is applied to the winning payline (step S26: YES), the control unit 22 applies the value to the award to be provided based on the symbols stopped in the cells forming the winning payline as step S28. Then, the control unit 22 provides an award as step S30. When it is determined that the value is not applied to the winning payline (step S26: NO), the control unit 22 provides the award determined based on the symbols stopped in the cells forming the winning payline without applying the value as the step S30. When it is determined that there is no winning (step S24: NO), or when the award is ended, the flowchart shown in FIG. 19 is ended.

As described above, in the gaming machine 10, a multiplier (value) may be provided to a plurality of paylines at a time by the chance area, and it is possible to provide a highly diversified game in a configuration in which a plurality of paylines to which the multiplier is applied and paylines to which the multiplier is not applied are mixed. As a result, the gaming machine 10 can provide a new game that continuously stimulates the player in various modes.

Although a multiplier of a predetermined value is provided to a winning award in the related art, the setting thereof is such that the value is uniformly provided regardless of a winning payline and is fixed and monotonous. On the other hand, in the present embodiment, chance areas (a first chance area 651 and a second chance area 652) are set on the payline table 650 displayed on the display 16, and an award booster (predetermined multiplier value) is applied only to paylines included in the chance area. Accordingly, in the present embodiment, a plurality of paylines to which multipliers are applied and paylines to which multipliers are not applied may be mixed, and an award amount finally obtained according to a payline in which winning occurs can be changed even in the same winning species. In this way, the player can be provided with an appropriate stimulus and a sense of satisfaction by increasing the expectation for a specific payline winning and causing the player to experience the success or failure of the payline winning. Further, in this embodiment, since the setting of the chance area is changed, it is possible to provide the player with a non-monotonous game and a stimulus. In addition, since the chance area is set on the payline table 650 displayed on the display 16 and is overlaid on the payline table 650, the player can easily recognize the payline to which the award booster is applied, receive a stimulus based on a specific expectation, and receive a stimulus based on success or failure of winning in the payline. Furthermore, in the present embodiment, since a plurality of the chance areas, i.e., the first chance area 651 and the second chance area 652, are provided, it is possible to provide more diverse and complex game developments and results.

The gaming machine 10 may be client computing devices, in which case the game is delivered from a network-server computer system to one or more client computing devices via a communication network. The processor of the client computing devices may be programmed to function as the control unit 22 of the gaming machine 10.

When the gaming machine 10 is used as a client computing device, 1) a rich client system may be used in which most of the processing involved in game execution is performed on the client side and results are transmitted to the server, 2) a thin-client system may be used in which only minimum processing is performed on the client side and main processing is performed on the server side, and 3) a zero client system may be used in which most of data storage and processing is performed on the server side and client specializes in input and output. In this case, the software configuration described in the embodiment is implemented and implemented in the client and the server.

In the above-described embodiment, a case has been described in which the virtual reel strips 72 to 80 are associated with each column of cells of the grid 68, however, it is also possible to associate an independent reel with each of the cells.

In the above-described embodiment, the control unit 22 may be set such that a plurality of chance areas overlaps each other. In the overlapping portion of the chance area, the award booster set for each chance area may be added or multiplied and applied to the award based on the symbol arrangement. As a result, the gaming machine 10 can further increase the volatility of the game, and can change the volatility of the game by changing the overlapping mode.

In the above-described embodiment, a jackpot tier may be assigned to the credit symbol instead of the credit amount. The jackpot tier is a level, such as MINI, MAJOR, MAXI, or MEGA, corresponding to the amount of the winning award.

In addition, the award booster may increase the award amount provided by upgrading the winning to jackpot winning when the winning by the credit symbol occurs in the payline of the chance area. When there is a plurality of the winning jackpot tiers, the winning jackpot tier may be determined by a random number, and the determination process may be represented by a reel, a wheel, or a roulette.

The function of the control unit 22 of the gaming machine 10 described above can also be realized by executing a program by a computer. That is, it is possible to create a program that causes one or more computers to function in the same manner as the control unit 22 described above. The program may be provided by being recorded in a computer-readable recording medium such as a ROM or a semiconductor memory. Such a program may be divided into a plurality of modules.

Additionally, various modifications can be made to the operation in each embodiment. For instance, a mode could be adopted where a necessary number of random numbers are acquired in advance to determine the reel stop positions. Once the winning of the special game and the determination of the presence or absence of winning are completed, the contents are sequentially displayed on the display. Moreover, for instance, the control unit 22 could collectively acquire a necessary number of random numbers at the start of the game. Each random number could then be stored in a storage area of the memory 42 or the storage 44, which is not erased even when there is a power source anomaly. In this scenario, even if a power failure or similar event occurs during the game, the control unit 22 can reproduce the game's progress. This is done by acquiring the random number, which was obtained at the start of the game before the power failure, from the memory 42 or the storage 44 when resuming the game after power restoration. For instance, if a power supply abnormality occurs just before the formation of a game result in which a high payout is obtained, a problem could arise if the same game does not proceed after power restoration. However, by collectively acquiring all random numbers at the start of the game and storing these numbers in the memory 42 or the storage 44 as described above, it is possible to reproduce the game's progress similar to that before the power source abnormality occurred, after power recovery. This way, such a problem can be avoided.

Additionally, in the described embodiment, a bill or a ticket represents the game value. The bill or ticket is received by the bill/ticket identification unit, and the ticket is output by the printer unit. However, the present disclosure is not limited to this setup. The game value concept includes tangible objects like coins, bills, medals, or tickets, as well as electronic data such as virtual credits or virtual currencies with equivalent value. For instance, a coin acceptor could accept coins and dispense coins from a coin hopper. One mode could involve identifying a player and using credits accumulated in a server account, with credits being paid out to the account. Alternatively, a mode could be adopted where credit information recorded on a storage medium like a magnetic card or an IC card is read and used, with credits being paid out by writing the information back to the storage medium. Furthermore, credits could be electronically transferred to and from a smartphone or a wearable device.

What is claimed is:

1. A gaming machine comprising:
an operation unit configured to receive an operation of a player;
a display unit including a symbol display area and a payline display area, the symbol display area configured to display symbols in cells arranged in a grid and being set a plurality of paylines, each payline including a part of the cells, the payline display area configured to display a payline table indicating a part or all of the paylines; and
a control unit connected to the operation unit and the display unit, configured to change and stop the symbols displayed in the symbol display area in response to receiving the operation of the player by the operation unit, and provide an award based on the symbols stopped in the cells forming the payline, wherein the control unit is configured to:
set a chance area associated with an award booster to include a part of paylines indicated in the payline table, the award booster increasing the award; and
increase the award using the award booster set in the chance area, the award provided based on the symbols stopped in the cells forming the payline included in the chance area.

2. The gaming machine according to claim 1, wherein the control unit sets the chance area for each game that is started by changing the symbols and is ended by stopping the symbols and providing the award based on the symbols stopped in the cells forming the payline.

3. The gaming machine according to claim 1, wherein the control unit sets the chance area each time a game is executed a predetermined number of times, the game being started by changing the symbols and ending by stopping the symbols and providing the award based on the symbols stopped in the cells forming the payline.

4. The gaming machine according to claim 1, wherein the control unit sets a plurality of chance areas for the payline table.

5. The gaming machine according to claim 1, wherein the control unit displays a position of the chance area and a content of the award booster in the payline display area after starting changing the symbols.

6. The gaming machine according to claim 1, wherein the control unit sets the chance area to a fixed position of the payline table.

7. The gaming machine according to claim 1, wherein the control unit sets the chance area to a randomly determined position of the payline table.

8. The gaming machine according to claim 1, wherein the control unit applies a value to the award to be provided based on the symbols stopped in the cells forming the payline by the award booster.

9. The gaming machine according to claim 8, wherein the control unit sets the value applied by the award booster to a randomly determined value.

10. A gaming method for providing a game using a gaming machine, the gaming machine comprising:
an operation unit configured to receive an operation of a player;
a display unit including a symbol display area and a payline display area, the symbol display area configured to display symbols in cells arranged in a grid and being set a plurality of paylines, each payline including a part of the cells, the payline display area configured to display a payline table indicating a part or all of the paylines; and
a control unit connected to the operation unit and the display unit, configured to change and stop the symbols displayed in the symbol display area in response to receiving the operation of the player by the operation unit, and provide an award based on the symbols stopped in the cells forming the payline, the gaming method executed by the control unit, comprising:
setting a chance area associated with an award booster to include a part of paylines indicated in the payline table, the award booster increasing the award; and
increasing the award using the award booster set in the chance area, the award provided based on the symbols stopped in the cells forming the payline included in the chance area.

11. A non-transitory computer-readable storage medium storing a program for a gaming machine providing a game to a player, the gaming machine comprising:
an operation unit configured to receive an operation of a player;
a display unit including a symbol display area and a payline display area, the symbol display area configured to display symbols in cells arranged in a grid and being set a plurality of paylines, each payline including a part of the cells, the payline display area configured to display a payline table indicating a part or all of the paylines; and
a control unit connected to the operation unit and the display unit, configured to change and stop the symbols displayed in the symbol display area in response to receiving the operation of the player by the operation unit, and provide an award based on the symbols stopped in the cells forming the payline, the program configured to cause the control unit to:
set a chance area associated with an award booster to include a part of paylines indicated in the payline table, the award booster increasing the award; and
increase the award using the award booster set in the chance area, the award provided based on the symbols stopped in the cells forming the payline included in the chance area.
